(19) United States
(12) Patent Application Publication
(10) Pub. No.: US 2017/0036345 A1
(43) Pub. Date: Feb. 9, 2017

(54) Robot For Industrial Use

(71) Applicant: Comau S.p.A., Grugliasco (torino) (IT)

(72) Inventors: Stefano Bordegnoni, Grugliasco (Torino) (IT); Francesco Ciniello, Grugliasco (Torino) (IT)

(21) Appl. No.: 15/223,023

(22) Filed: Jul. 29, 2016

(30) Foreign Application Priority Data
Aug. 3, 2015 (IT) 102015000041279

(51) Int. Cl. B25J 9/04; B25J 9/12

(52) U.S. Cl. CPC B25J 9/044; B25J 9/126

(57) ABSTRACT

An industrial SCARA-type robot having a terminal body with telescopic elements. The telescopic elements include coaxial tubular and shaft elements which selectively extend or retract to position an operating unit to engage a product. The telescopic elements contract to a minimum axial extension length for tightly spaced applications.

### FIELD OF INVENTION

The invention generally relates to programmable robots for exemplary use in industrial manufacturing and assembly.

### BACKGROUND

Robots known by the acronym SCARA (Selective Compliance Assembly Robot Arm), are characterized in that they enable lateral displacements in a horizontal plane according to extremely fast movements of rotation. For this reason, they are prevalently used for applications of a pick-and-place kind, where the robot, via the operating unit associated thereto, simply picks up products in succession from a first station and deposits them in a second station set alongside. The movement of translation referred to above, which occurs along the vertical, is used for picking up and releasing the products by the operating unit in the different stations, according to movements of lowering and raising of the unit. An example of the above robot is described in U.S. Patent Application Publication No. US 2005/0087034 A1.

In the known solution referred to above, the means designed to control the connector member according to a movement of rotation and translation about and along one and the same axis, comprise a screw shaft, constrained to which are the connector member and an internal-screw assembly that engages the shaft. A first motor is associated to the shaft, whereas a second motor is associated to the internal-screw assembly, and actuation of one or both of the motors brings about rotation of the shaft and/or raising or lowering thereof.

In this known solution, the length of the screw shaft referred to above must be at least equal to the sum of the amount of the displacement required along the second axis and of the vertical encumbrance of the body of the robot by which it is carried.

The presence of the above shaft hence increases considerably the overall vertical encumbrance of, or physical space required by, the arm of the robot, this limiting in a non-negligible way the applications for use thereof.

### SUMMARY

The object of the present invention is to overcome the above drawback of the known solution in question.

The present invention improves on or resolves the above drawbacks by providing a robot, in particular a robot for industrial use, of the type including at least one first robot body and one second robot body connected together in an articulated way about a first axis. An end connector member is mounted on said second body. An operating unit, for example a gripping tool, may be connected to the connector member. Further included are means for moving said end connector, which are configured for moving said end connector, selectively or simultaneously, according to a movement of rotation about a second axis of said robot parallel to said first axis and according to a movement of translation along said same second axis.

These and other aspects of the present disclosure are disclosed in the following detailed description of the embodiments, the appended claims and accompanying drawing figures.

### BRIEF DESCRIPTION OF THE DRAWINGS

The invention will now be described, purely by way of non-limiting example, with reference to the accompanying drawings.

FIG. 1 is a schematic illustration of an example of the inventive robot;

FIGS. 2a and 2b are schematic illustrations of the terminal portion of the robot of FIG. 1 in two alternate positions;

FIGS. 3a, 3b, and 3c illustrate the terminal portion of FIGS. 2a and 2b in three respective different operating conditions; and

FIG. 4 illustrates an alternate example of the inventive robot.

### DETAILED DESCRIPTION

In the ensuing description, various specific details are illustrated with the aim of providing an in-depth understanding of the embodiments or examples. The embodiments may be implemented without one or more of the specific details, or with other methods, components, or materials, etc. In other cases, known structures, materials, or operations are not shown or described in detail so that the various aspects of the embodiment will not be obscured.

The drawings and number references used herein are provided only for convenience and hence do not define the sphere of protection or the scope of the embodiments.

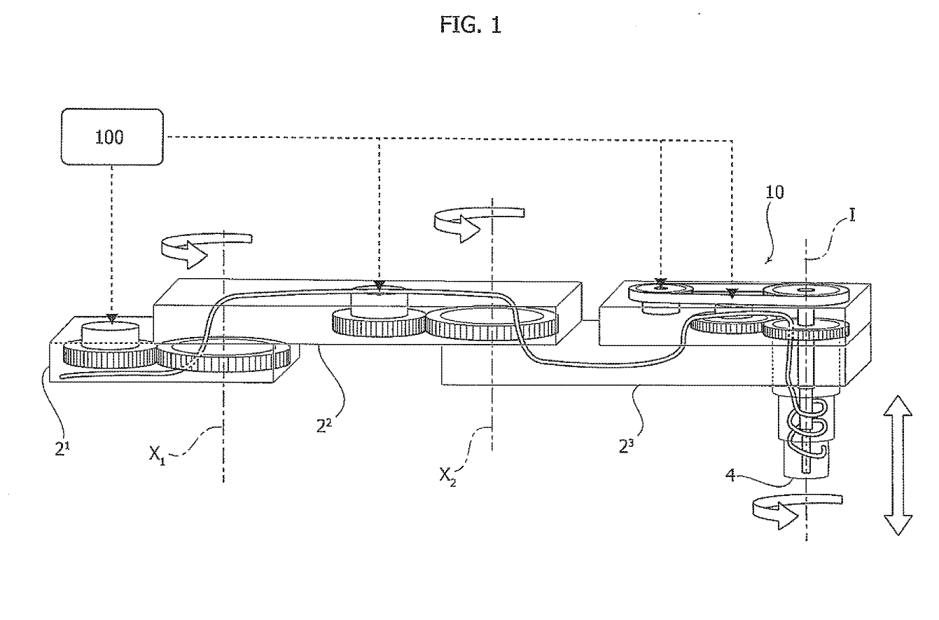

With reference to the FIGS. 1-4 are embodiments of the inventive robot described herein, which is designated as a whole by the reference number 10. This type of robot is also defined by the acronym SCARA.

The robot 10 comprises a series of bodies 2 (three shown 2¹, 2², and 2³) connected together in an articulated way about respective mutually parallel axes X (two shown X₁ and X₂); in the example illustrated, the bodies 2 are three in number and are designated by the references 2¹, 2², and 2³. The two exemplary axes of articulation X of this series of bodies are designated by the references X₁ and X₂. It is understood that a greater or lesser number of bodies 2 and associated axis X may be used depending on the application and as known by those skilled in the art.

The means or devices for driving the different bodies 2 in rotation about the respective axes of rotation X may present any configuration known in the art, and consequently will not be described in detail herein. In this connection, FIG. 1 illustrates by way of example, for each axis of rotation X, a device including an electric motor and gears designed to control rotation of the respective body 2, which is rotatable about the aforesaid respective axis X.

As is already known from the prior art, the first body 2¹ of the series referred to above is in turn mounted on a slide (not illustrated), which is usually mobile vertically or horizontally but could clearly move also in other directions. It is in any case also possible to envisage embodiments of the robot 10 described herein in which the body 2 is, instead, mounted on a fixed structure.

The terminal body 2³ in the series carries an end connector member 4, to which an operating unit (not illustrated), for example a gripping member, is to be connected. In particular, the terminal body 2³ comprises means or devices designed to impart on the end member 4 a movement of rotation about an axis I and, moreover, a movement of linear translation along the same axis I. In the example, the axis I is parallel to the other axes X₁ and X₂ and defines the operating axis of the robot. In the exemplary applications of a pick-and-place kind of robot, the robot operates, on the one hand, through the movement of linear translation, for picking up and depositing the products (not shown), and, on the other hand, through the movement of rotation, for orienting the products in specific positions at the moment when they are deposited.

The terminal body 2³ may alternately be moved in space through the rotations about the axes X₁ and X₂ of the body 2³ itself and of the body 2², as well as through the movement of the slide (not shown) by which the series of the bodies 2 is possibly carried.

The exemplary robot 10 described herein is characterized in that the terminal body 2³ comprises a series of tubular elements 6 (three shown) connected together according to a telescopic configuration. In a preferred embodiment, positioned between each tubular element 6 of the series and the next are screw means or devices 11, designed to convert the relative rotation between the two consecutive tubular elements 6 of the series into a simultaneous movement of linear translation of one tubular element 6 with respect to another tubular element 6 along axis I. In the example illustrated, the tubular elements 6 are three in number and are designated in the figures by the references 6¹, 6², 6³. In various embodiments, the screw means or devices 11 have all the same direction of twist of the thread. In various preferred embodiments, the screw means 11 are a ballscrew system. It is understood that the screw means or devices 11 may be of any type known to the art that is suitable for the purposes indicated.

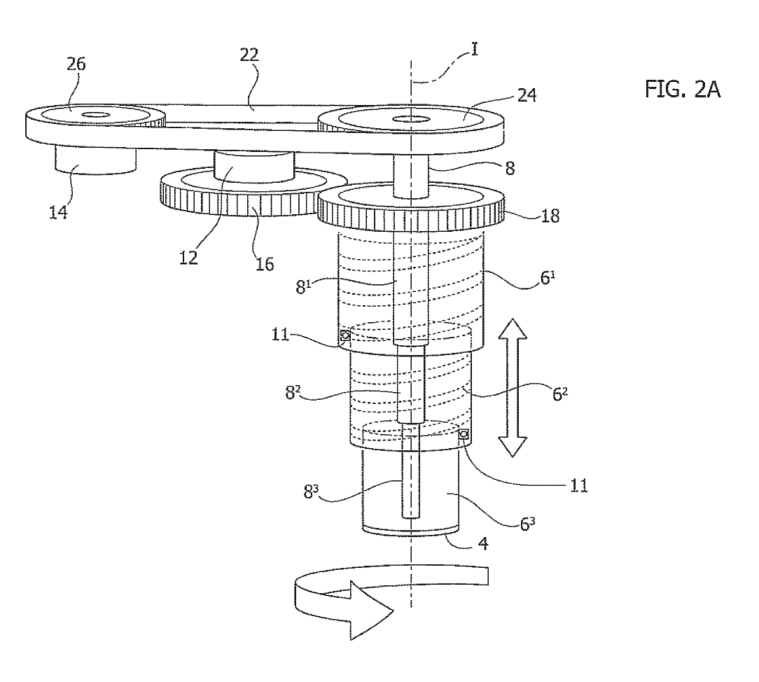

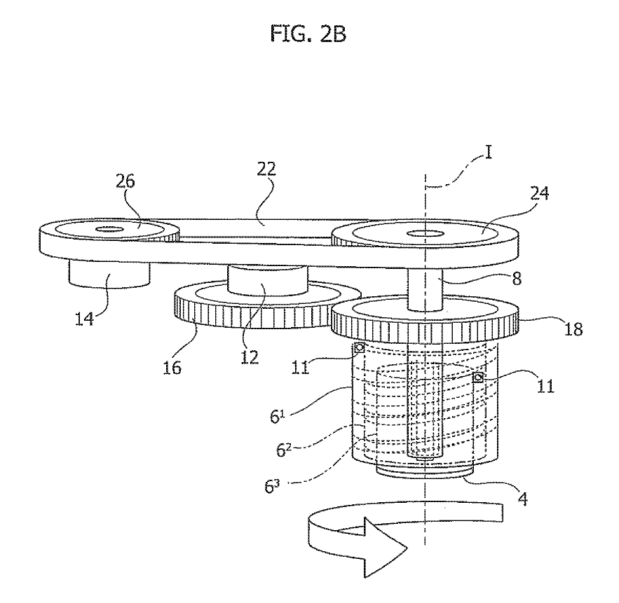

Referring to the example shown in FIGS. 2A and 2B, the first tubular element 6¹ of the series is driven in rotation about the axis I via a specifically dedicated motor 12. Mounted on the last element 6³ of the series is the connector member 4. An operating unit (not shown), is selectively connected to the connector member 4. The operating unit may be a component gripper or other end effector useful for grasping or manipulating objects known by those skilled in the art

The terminal body 2³ (not shown in FIGS. 2A and 2B) further comprises a shaft 8, which preferably includes a series of shaft elements 8 that are also connected together according to a telescopic configuration. Preferably, this series of shafts 8 is in the same number of shafts as the series of the tubular elements 6, even though it is in any case possible to envisage embodiments where the number of the shaft elements is instead greater than the number of tubular elements 6 and vice versa. The shaft elements of the exemplary series are designated by the references 8¹, 8², 8³. These shaft elements are constrained together in rotation as a result of a mutual shape fit; this type of fit may, for example, be obtained via appropriate complementary grooved profiles, made on the inner and/or outer surfaces of the shaft elements (not shown).

The last shaft element 8³ is constrained or connected to the last tubular element 6³ of the series of tubular elements. In a preferred example, the element 8³ is fixed to the element 6³ so as to follow it, or be followed thereby, both in the movements of rotation and in the movements of linear translation. The first shaft element 8¹ is preferably fixed in position on the terminal body 2³ and is driven in rotation via a specifically dedicated motor 14.

In various embodiments, as in the one illustrated in FIGS. 2A and 2B, the motor 12 is preferably a motor-reducer, and the first tubular element 6¹ is kinematically connected thereto by way of a gear 16 coupled to the output shaft of the motor-reducer 12, which meshes directly with a gear 18 fixed with respect to the first tubular element 6¹. In the example, the motor 14 is preferably a motor-reducer, and the shaft 8 is kinematically connected thereto by way of a belt 22, which connects rotationally together a wheel 24 fixed with respect to the element 8¹ and a wheel 26 coupled to the output shaft of the motor-reducer 14. It is understood that the two kinematic connections described above may also be reversed. For example, the connection of motor 14 to the shaft 8 may be made by gears similar to 16 and 18, and the connection by motor 12 to first tubular element 6¹ by a belt similar to 22.

In general, it is understood that the combination of these two exemplary kinematic connections for connecting the motors 12 and 14 to the tubular elements 6¹ and shaft elements 8¹ enables optimal exploitation of the spaces and hence limitation or reduction of the overall exterior or spatial dimensions of the terminal body 2³ itself. It is in any case clearly possible to provide also kinematic connections of some other type, according to the requirements of the specific applications as known by those skilled in the art.

In various embodiments, as in the one illustrated, the robot 10 moreover comprises a control unit 100, configured for controlling driving of the various motors of the robot 10. Control unit 100 is preferably a programmable controller in communication with a data memory storage device for storing computer or software instructions and a processor for executing the programmable instructions through the controller (not shown). Other hardware and software for operating a robot known by those skilled in the art may be used.

With reference now to an exemplary operation of the robot 10 shown in FIGS. 2A and 2B, the series of tubular elements 6¹, 6², 6³ can be moved through the actuation of the motor 12 between two end conditions or positions: a first condition of minimum linear extension along axis I in which the various tubular 6 and shaft 8 elements are arranged inside one another (FIG. 2B), and a condition or position of maximum linear extension in which each tubular 6 and shaft 8 element has each reached its condition of maximum extraction or extension with respect to the element by which it is carried (FIG. 2A). As a result of the mutual constraint or connection on the last tubular element 6³, the shaft elements 8¹, 8², 8³ of the shaft 8 follow this movement of translation along the axis I. In this exemplary connection, FIG. 2A illustrates precisely a condition of operation of the robot 10 in which the tubular elements 6¹, 6², 6³ move in translation along the axis I solely as a result of actuation by the motor 12.

In an alternate exemplary operation of robot 10, rotation of the element 6³ about the axis I is brought about by the shaft 8, which is driven by the motor 14. It is understood that this rotation is in itself such as to induce displacement of the last tubular element 6³ itself with respect to the tubular element 6² along the axis I as a result of the presence of the screw means or device 11, which act in the sense of converting the relative rotation between the element 6³ and the element 6² into a simultaneous relative linear translation movement of the two elements along the axis I.

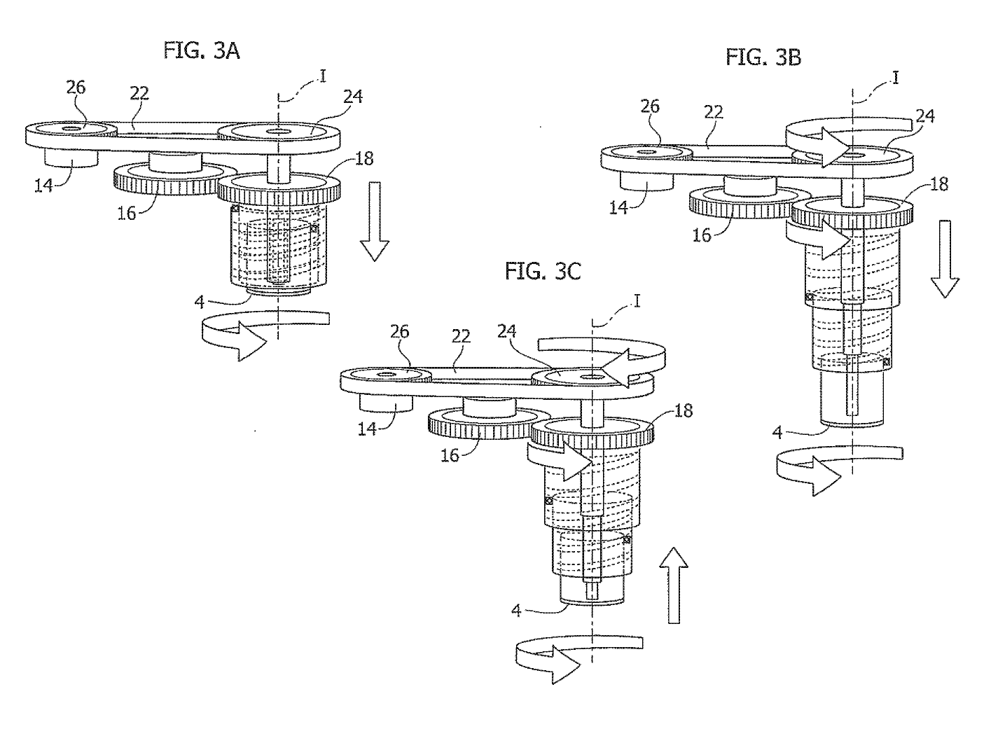

In an alternate example, where the last tubular element 6³ is required to turn and translate simultaneously, the control unit 100 drives, on the one hand, the motor 12 so as to bring about the desired rotation of the element 6³ and, at the same time, drives the motor 14 to set the first tubular element 6¹ in rotation according to an appropriately differentiated motion with respect to the last tubular element 6³ so as to provide the desired axial displacement of the ensemble of the tubular elements 6¹, 6², and 6³. This condition of operation is illustrated in FIG. 3C.

In view of the foregoing, the control unit 100 of the robot is hence configured for controlling the first and second motors 12 and 14 selectively or simultaneously so as to provide respectively:
a first operating mode, where the shaft 8 and the element 6¹ turn in the same direction and at the same speed (for example FIG. 3B);
a second operating mode, where the element 6¹ turns in a given direction and at a given speed, whereas the shaft 8 does not turn (for example FIG. 3A); and
a third operating mode, where the shaft 8 and the element 6¹ turn in different directions and/or at different speeds (for example FIG. 3C).

In various preferred embodiments, as in the one illustrated, in the condition or position of minimum extension of the series of the tubular elements 6, these are for the most part lie or are positioned within the overall exterior dimensions of the structure of the terminal body 2³ by which they are carried. In various particularly preferred embodiments, when the series of the elements 6 is in the condition or position of minimum extension, the overall vertical encumbrance of, or physical space occupied by, the body 2³ is equal to or less than half of its overall vertical encumbrance when the series of tubular elements 6 is in the condition or position of maximum extension.

With reference now to FIG. 2B, which illustrates the condition of minimum extension, it appears evident that, thanks to this condition that the robot 10 described herein can assume, the robot 10 can operate without any problems, even in applications in which the space available for manoeuvre, most preferably vertically, constitutes a particularly useful advantage. In this example, the robot 10 described herein may in particular be used in applications where multiple robots are provided, which operate simultaneously in working spaces that overlap, or, again, in applications where the robot is required to pass through passages that are particularly narrow and limited in height, defined, for example, by partition panels that separate two distinct working areas.

Finally, as generally shown in FIG. 1, it should be noted that the telescopic series of tubular elements 6 may also be advantageously used to containing the possible cables and/or tubes for supply and/or control that are to be connected to the operating unit (not shown) carried by the robot 10. In various preferred embodiments, the aforesaid cables and tubes are wound according to a helical configuration about the shaft 8. This exemplary arrangement enables the cables and tubes to follow the axial displacement and rotation of the operating unit carried by the member 4 without any risk of getting twisted and limiting sliding thereof with respect to the surrounding parts in order to safeguard their integrity.

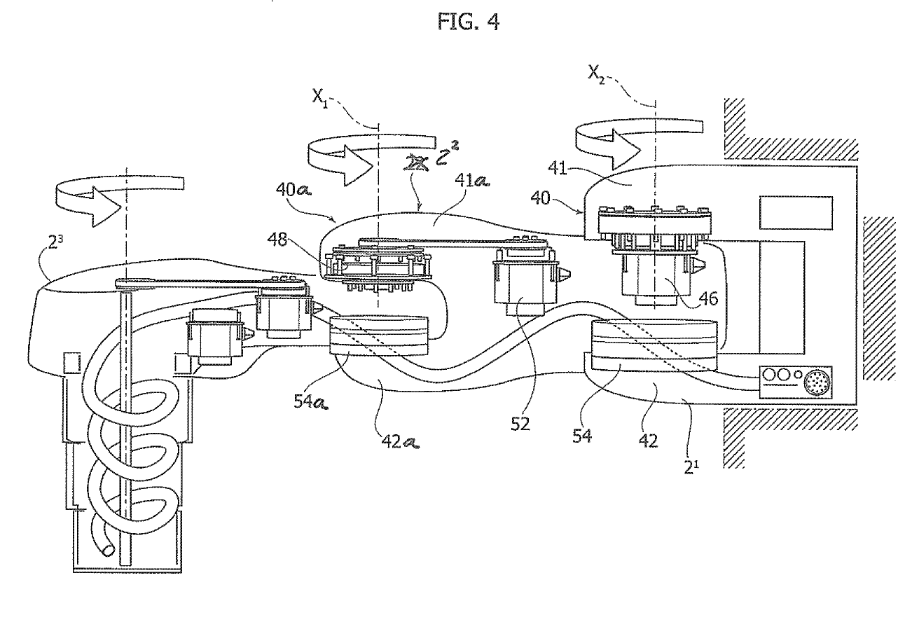

In various embodiments, as in the one illustrated in FIG. 4, all the bodies 2¹ and 2² of the series that are articulated together, except for the terminal body 2³, have an end portion 40 preferably having a forked configuration, mounted in an articulated way on which is the next or additional body 2 of the series. The forked portion is provided with two opposite arms 40, 42 and 40a, 42a, which are engaged by the body 2 via interposition of bearing members 54, 54a. In various embodiments, as in the one illustrated, one of the two arms of the forked portion 40 houses at least part of the means or device 46 for driving the body 2 in rotation, whereas housed on the opposite arm is a bearing member 54 provided with a central opening designed to enable passage of the cables and tubes for supply/control of the operating unit and/or of the possible wiring of the means for actuation of the bodies 2 of the series downstream. In particular, with reference to the embodiment illustrated in FIG. 4, the arm 41 of the body 2¹ houses the stator part of a motor-reducer 46 mounted in the body 2², whereas the arm 41a of the latter houses a reducer 48 that is connected to a motor 52 via an exemplary belt transmission. In the arms 42, 42a of the bodies 2¹ and 2² there are, instead, housed two bearings 54, 54a provided with the central opening for passage of the equipment and/or the wiring mentioned previously.

Thanks to the characteristics referred to above, in the robot 10 described herein the tubes and/or cables that lead to the operating unit, as likewise the wiring that leads to the means or device for actuation of the various articulated bodies 2, pass completely within the arm of the robot, starting from the exemplary first body 2¹ of the series up to the terminal body 2³ , without ever emerging on the outside. This affords the advantage, on the one hand, of guaranteeing protection for the cables and tubes themselves, and, on the other, of preventing these from possibly getting tangled up with other elements present in the working area of the robot and thus hindering free movement thereof.

It should be noted that the same advantage is also achieved in the embodiment illustrated in FIGS. 1-3, as it may likewise be achieved also in other embodiments of the robot described herein.

In general, as described above, the exemplary robot 10 envisages for this purpose, on various axes of articulation of the bodies of the robot, bearing members provided with a central opening designed to enable passage of the aforesaid cables and/or tubes.

It is also understood that the robot 10 described herein can also present a configuration different from the one typical of a SCARA robot. For instance, it may present the configuration typical of an articulated or anthropomorphic robot. In this example, the bodies 2 of the robot will be articulated with respect to one another about axes variously oriented in space, and likewise the operating axis I of the terminal body may be variously oriented with respect to one or more of the other axes of the robot according to the requirements of the specific applications. Apart from these aspects, the robot will continue in any case to present all the characteristics that have been mentioned previously.

In preferred embodiments, the exemplary articulated robot 10 may be of the hollow-wrist type, and in this case the supply and/or control tubes and/or cables that traverse the wrist, directly reach the space inside the tubular elements 6 described above, without ever emerging on the outside of the structure of the wrist.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A robot for use with an operating unit in industrial applications, the robot comprising:
at least one first and one second robot body connected together in an articulated way about a first axis; and
an end connector member mounted on said second body;
wherein said second body comprises means for moving said end connector, the means configured for moving, selectively or simultaneously, said end connector according to a movement of rotation about a second axis of said robot positioned parallel to said first axis and according to a movement of linear translation along said same second axis,
said robot being characterized in that said second body further comprises:
a first series of elements telescopically connected together in such a way that said first series of elements can vary in length along said second axis from a position of minimum extension to a position of maximum extension, wherein a screw device is positioned between each element of said first series and the next; and
a shaft having a series of shaft elements telescopically connected together;
wherein a last shaft element of said shaft series is constrained to a last element of said first series and wherein said end connector member is carried by said last element of said first or shaft series,
wherein said robot connector moving means comprises a first motor configured to control rotation of a first element of said first series and a second motor configured to control rotation of said shaft.

2. The robot according to claim 1 further comprising a control unit configured for controlling said first and second motors selectively or simultaneously, the control unit further comprising:
a first operating mode of said robot, wherein said shaft and said first element of said first series rotate in the same direction and at the same speed;
a second operating mode, wherein said first element of said first series rotates in a first direction and at a first speed, and said shaft does not rotate; and
a third operating mode, wherein said shaft and said first element of said first series rotate in at least one of different directions or at different speeds.

3. The robot according to claim 1, wherein said screw device positioned between each element of said first series each have the same direction of a twist of a thread.

4. The robot according to claim 1, wherein said shaft elements of said shaft are constrained together in rotation via a shape fit.

5. The robot according to claim 1, wherein the elements of said first series comprise tubular elements and wherein said shaft is coaxially positioned within said tubular elements.

6. The robot according to claim 5 further comprising at least one of a tube or cable for at least one of a supply or control of said operating unit, said at least one of said tube or cable being positioned around said shaft in a helical configuration.

7. The robot according to claim 1, wherein said elements of said first series and said screw device are configured to define a minimum extension position, when said elements of said first series are telescoped into one another.

8. The robot according to claim 7, wherein when said first series elements are in said position of minimum extension, a minimum extension position axial vertical length of said second body is equal to or less than one-half of a maximum extension position axial vertical length of said second body.

9. The robot according claim 1 further comprising a bearing member engaged with the first and the second body, the bearing member defining a central opening for passage of at least one of cables or tubes that traverse said first and second bodies.
